(19) United States
(12) Patent Application Publication
(10) Pub. No.: US 2026/0158396 A1
(43) Pub. Date: Jun. 11, 2026

(54) Machine-Learning-Based Game Companion Agent

(71) Applicant: GDM Holding LLC, Mountain View, CA (US)

(72) Inventors: Christopher Thomas Gamble, Chipping Norton (GB); Duncan David Ross Williams, Malvern (GB); Yunlong Jiao, Hatfield (GB); Bethanie Hope Brownfield, London (GB); Rushil Sharad Mistry, Brooklyn, NY (US); Sofia Samaniego de la Fuente, London (GB); Stephen Robert Hardwick, London (GB); Sultan Kenjeyev, London (GB)

(21) Appl. No.: 19/416,979

(22) Filed: Dec. 11, 2025

Related U.S. Application Data
(60) Provisional application No. 63/730,762, filed on Dec. 11, 2024.

(51) Int. Cl. A63F 13/67; A63F 13/215

(52) U.S. Cl. CPC A63F 13/67; A63F 13/215

(57) ABSTRACT

Provided are systems and methods for a game companion agent that enhances a user's experience with an interactive video game. In particular, the game companion agent can dynamically integrate observation data associated with the game environment (e.g., video data that depicts the game environment) with user inputs (e.g., user speech inputs) to provide context-sensitive responses, commentary, and/or assistance relative to the video game. In particular, in some implementations the game companion agent can include or leverage a large multi-modal, machine-learned model (e.g., a machine-learned sequence processing model such as a Transformer model) to interpret and respond to user inputs in the context of the current game environment.

### RELATED APPLICATIONS

This application claims priority to and the benefit of U.S. Provisional Patent Application No. 63/730,762, filed Dec. 11, 2024, and titled “Machine-Learning-Based Game Companion Agent”. U.S. Provisional Patent Application No. 63/730,762 is hereby incorporated by reference in its entirety.

### FIELD

The present disclosure relates generally to machine learning processes and machine-learned devices and systems. More particularly, the present disclosure relates to a machine-learning-based game companion agent.

### BACKGROUND

A computer can receive input(s). The computer can execute instructions to process the input(s) to generate output(s) using a parameterized model. The computer can obtain feedback on its performance in generating the outputs with the model. The computer can generate feedback by evaluating its performance. The computer can receive feedback from an external source. The computer can update parameters of the model based on the feedback to improve its performance. In this manner, the computer can iteratively “learn” to generate the desired outputs. The resulting model is often referred to as a machine-learned model.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method. The computer-implemented method includes receiving, by a game companion agent, an input associated with a user. The method also includes sampling, by the game companion agent, a video stream associated with a user, where the video stream depicts an in-game environment associated with a video game played by the user. The method also includes generating, by the game companion agent, a model input based on (i) at least a portion of the video stream and (ii) the input associated with the user. The method also includes generating, by the game companion agent and based on processing the model input using a machine-learned sequence processing model, a model output. The method also includes outputting, by the game companion agent, and based on the model output, a response to the input associated with the user. Other embodiments of this aspect include corresponding computer systems, apparatus, and computer programs recorded on one or more computer storage devices, each configured to perform the actions of the methods.

Example implementations may include any combination of one or more of the following features. The computer-implemented method, where the input associated with the user may include a speech input uttered by the user. The input associated with the user may include a textual input entered by the user. The game companion agent proactively samples and processes video frames from the video stream. The game companion agent samples and processes video frames from the video stream in response to the input associated with the user. The game companion agent samples and processes video frames from a window before and after a timestamp associated with the input associated with the user. Generating, by the game companion agent, the model input may include performing, by the game companion agent and in response to the input, tool use to obtain contextual information from one or more external tools, where the contextual information is included in the model input. Generating, by the game companion agent, the model input may include performing, by the game companion agent and in response to the input, a web search to obtain contextual information from one or more web documents, where the contextual information is included in the model input. The method further may include maintaining, by the game companion agent, current session data associated with a current gaming session with the user, and generating, by the game companion agent, the model input may include generating, by the game companion agent, the model input based at least in part on the current session data. The method further may include maintaining, by the game companion agent, prior session data associated with one or more prior gaming sessions with the user, and generating, by the game companion agent, the model input may include generating, by the game companion agent, the model input based at least in part on the prior session data. The method further may include maintaining, by the game companion agent, interaction rules associated with interacting with the user, and generating, by the game companion agent, the model input may include generating, by the game companion agent, the model input based at least in part on the interaction rules. The interaction rules instruct the game companion agent to only comment on visual elements of the in-game environment when the user explicitly mentions the visual elements. The interaction rules instruct the game companion agent to tailor a response length based on a level of engagement associated with the user. The input may include an input generated based on captured audio, and where the interaction rules instruct the game companion agent to ignore non-linguistic noise contained within the captured audio. The interaction rules may include a set of tags that define delimitations of content contained in the video stream, the interaction rules, or the model output. The input associated with the user may include a request for gameplay assistance, and where the response to the input may include guidance relative to the in-game environment. Outputting, by the game companion agent, and based on the model output, the response to the input may include overlaying, by the game companion agent, one or more visual elements onto the video stream. The one or more visual elements may include arrows, links, or embedded content. Outputting, by the game companion agent, and based on the model output, the response to the input may include automatically performing, based on the model output, a game input action relative to game environment, the game input action affecting the game environment. The video stream may include imagery only. The video game is a touch-based or controller-based game in which the user interacts with the video game via touch interactions or via inputs to a physical controller. The game companion agent is separate from video game code executing the video game. The game companion agent is executed by one or more first computing devices and where the video game is executed by one or more second computing devices that are separate from the one or more first computing devices. The method can further include: validating, by the game companion agent, a cryptographic signature associated with the game companion agent against a trusted integrity API of the computing system; and performing the sampling of the video stream only upon receiving a successful integrity verdict that prevents interference from anti-tamper mechanisms associated with the video game. The method can further include: detecting, by the game companion agent, a loading state associated with the video game based on the observation data; and transmitting, by the game companion agent, a signal to a resource manager of the computing system to temporarily increase a clock speed of a processor associated with the computing system during the loading state. The method can further include: monitoring, by the game companion agent, engagement metrics including at least one of session duration or achievement progress; transmitting, by the game companion agent, the engagement metrics to a remote platform service associated with an application store; and receiving, from the remote platform service, data indicative of a reward or a loyalty point balance update to be displayed to the user via the game companion agent. The game companion agent can be contained within video game code executing the video game. The video stream may include both imagery and audio. Other aspects include: A computer system configured to perform any of the methods described herein. One or more non-transitory computer-readable media that store computer-executable instructions for performing any of the methods described herein. Implementations of the described techniques may include hardware, a method or process, or computer software on a computer-accessible medium.

One general aspect includes a computer-implemented method. The computer-implemented method also includes receiving, by a game companion agent, an input associated with a user. The method also includes obtaining, by the game companion agent, observation data descriptive of an in-game environment associated with a video game played by the user. The method also includes generating, by the game companion agent, a model input based on (i) at least a portion of the observation data and (ii) the input associated with the user. The method also includes generating, by the game companion agent and based on processing the model input using a machine-learned sequence processing model, an output. The method also includes outputting, by the game companion agent, and based on the output, a response to the input associated with the user. Other embodiments of this aspect include corresponding computer systems, apparatus, and computer programs recorded on one or more computer storage devices, each configured to perform the actions of the methods. Implementations may include one or more of the following features. The computer-implemented method where the observation data may include video data. Implementations of the described techniques may include hardware, a method or process, or computer software on a computer-accessible medium.

One general aspect includes a computer-implemented method. The computer-implemented method also includes receiving, by an interactive agent, an input associated with a user. The method also includes obtaining, by the interactive agent, observation data descriptive of an interactive environment with which the user is interacting. The method also includes generating, by the interactive agent, a model input based on (i) at least a portion of the observation data and (ii) the input associated with the user. The method also includes generating, by the interactive agent and based on processing the model input using a machine-learned sequence processing model, an output. The method also includes outputting, by the interactive agent, and based on the output, a response to the input associated with the user. Other embodiments of this aspect include corresponding computer systems, apparatus, and computer programs recorded on one or more computer storage devices, each configured to perform the actions of the methods.

Example implementations may include any combination of one or more of the following features. The method where the interactive environment may include a user interface environment of a software application, and where the observation data optionally includes a visual depiction of the user interface, and where the response optionally includes an action to be performed relative to the user interface. The interactive environment may include a home automation system, and where the observation data optionally includes data from sensors monitoring one or more home devices, and where the response optionally includes a control signal to at least one of the one or more home devices. The interactive environment may include an educational software environment, and where the observation data optionally includes student input or performance metrics, and where the response optionally includes adaptive educational feedback tailored to the student input or performance metrics. The interactive environment is a customer service environment, and where the observation data optionally includes a history of customer interactions, and where the response optionally includes a response to a customer query based on the history of customer interactions. The interactive environment is an autonomous vehicle, and where the observation data optionally includes telemetry or perception data associated with the autonomous vehicle, and where the response optionally includes navigational or control signals to the autonomous vehicle. The interactive environment is a virtual reality environment, and where the observation data optionally includes user interaction data within the virtual environment, and where the response optionally includes guidance or narrative progression cues within the virtual reality environment. The interactive environment may include a healthcare setting, and where the observation data optionally includes patient health records, and where the response optionally includes medical appointment scheduling or reminders or diagnostic assistance. The interactive environment is a manufacturing setting, and where the observation data optionally includes real-time production line data, and where the response optionally includes adjustments to manufacturing processes or control signals to manufacturing robotics or systems. The interactive environment is a space exploration setting, and where the observation data optionally includes spacecraft telemetry or perception data, and where the response optionally includes maneuvers, adjustments, or control signals to spacecraft systems. The interactive environment is a logistics and supply chain management setting, and where the observation data optionally includes inventory levels or delivery schedules, and where the response optionally includes optimized routing suggestions for delivery vehicles or warehouse robotics. The interactive environment is an agricultural setting, and where the observation data optionally includes soil health data or crop growth metrics or weather data, and where the response optionally includes irrigation or planting recommendations or agricultural machinery control inputs. Implementations of the described techniques may include hardware, a method or process, or computer software on a computer-accessible medium.

### BRIEF DESCRIPTION OF THE DRAWINGS

FIG. 1 is a block diagram of an example computing system that includes a gam companion agent according to example implementations of aspects of the present disclosure;

FIG. 2 is a flow chart diagram illustrating an example method for training a machine-learned model according to example implementations of aspects of the present disclosure;

FIG. 3 is a block diagram of an example processing flow for using machine-learned model(s) to process input(s) to generate output(s) according to example implementations of aspects of the present disclosure;

FIG. 4 is a block diagram of an example sequence processing model according to example implementations of aspects of the present disclosure;

FIG. 5 is a block diagram of an example technique for populating an example input sequence for processing by a sequence processing model according to example implementations of aspects of the present disclosure;

FIG. 6 is a block diagram of an example model development platform according to example implementations of aspects of the present disclosure;

FIG. 7 is a block diagram of an example training workflow for training a machine-learned model according to example implementations of aspects of the present disclosure;

FIG. 8 is a block diagram of an inference system for operating one or more machine-learned model(s) to perform inference according to example implementations of aspects of the present disclosure;

FIG. 9 is a block diagram of an example networked computing system according to example implementations of aspects of the present disclosure;

FIG. 10 is a block diagram of an example computing device according to example implementations of aspects of the present disclosure; and

FIG. 11 is a block diagram of an example computing device according to example implementations of aspects of the present disclosure.

### DETAILED DESCRIPTION

Example aspects of the present disclosure are directed to systems and methods for a game companion agent that enhances a user's experience with an interactive video game. In particular, the game companion agent can dynamically integrate observation data associated with the game environment (e.g., video data that depicts the game environment) with user inputs (e.g., user speech inputs) to provide context-sensitive responses, commentary, and/or assistance relative to the video game. In particular, in some implementations the game companion agent can include or leverage a large multi-modal, machine-learned model (e.g., a machine-learned sequence processing model such as a Transformer model) to interpret and respond to user inputs in the context of the current game environment.

As one example, a game companion agent can enhance player interaction by processing both user inputs and video streams in real-time. The agent can receive inputs from the user, which could be in the form of voice commands or typed requests. Concurrently, the agent can sample a video stream that displays the current in-game environment that the user is interacting with. The agent can construct a model input that integrates both the user's inputs and the visual context of the game. The agent can use a machine-learned sequence processing model to generate a model output, which is then used to formulate a response from the agent to the input.

This response can then be delivered to the user as actionable advice, strategic game insights, and/or direct in-game assistance, thereby creating a more interactive and engaging gaming experience. As one example, the agent's response can be provided via output text and/or via output audio generated by a text-to-speech system. As another example, the agent's response can include overlaying visual elements such as arrows or links directly onto the game's video stream.

Thus, the present disclosure can significantly enhance user engagement by generating responses to the user that account for current game context or state. For instance, if a user asks for help during a game, the agent can provide instructions or specific advice that is responsive to the user's request for assistance. For example, if a user asks for help finding a hidden item in the game, the agent can analyze the video stream to identify potential locations and then guide the user accordingly.

More particularly, aspects of the present disclosure are directed to a machine-learning-based game companion agent that interacts with a user (e.g., via user input) while the user plays a video game. A video game can include an electronic game that involves interaction with a user interface or input device - such as a joystick, controller, keyboard, or motion sensing device - to generate visual feedback. This feedback is often displayed on a screen, but can also be projected in three-dimensional space. Video games are characterized by their interactive elements, often involving scenarios where players must solve problems, engage with other characters, or achieve specific goals in order to progress through the game levels. In general, the state of the video game and/or video game elements thereof can be referred to as the video game environment.

In some implementations, the game companion agent is configured to receive observations of the game environment, which can include a variety of data types such as video streams, audio inputs, and/or direct game state information. These observations enable the agent to analyze and understand the current state of the video game environment.

In some implementations, the game companion agent may access a video stream that depicts the video game environment. The agent can obtain the video stream through various methods. One method could include the agent directly accessing the video output from the game itself, either through integration within the game's code or via an API that streams game data. Alternatively, the agent could capture the video stream from a display device, such as a monitor or television, where the game is being displayed, using a connected camera or a built-in capture card. Another approach might include using an external camera set up to observe the display screen, providing the agent with a real-world view of what the user sees.

In some implementations, the game companion agent can process different types of video streams to enhance user interaction. The video stream can consist solely of imagery, allowing the agent to analyze visual elements such as game graphics, movements, and changes in the game environment without audio distractions. Alternatively, the video stream can include both imagery and audio, enabling the agent to integrate visual analysis with auditory cues. This audio-visual input allows the agent to provide more context-aware responses by correlating visual events with sounds, such as recognizing dialogue, sound effects, or audio cues that indicate specific actions or changes within the game.

In some implementations, the game companion agent is designed to receive inputs from the user. This agent can analyze and respond to user requests or commands within the context of the gameplay, as described herein.

In some implementations, the game companion agent can accommodate various forms of user inputs to enhance interaction flexibility within the gaming environment. As example, the game companion agent can accept inputs that are either speech-based or text-based. For instance, a user can verbally request assistance or strategies directly through a microphone, and the agent processes this speech input to understand and act upon it. Alternatively, the user can type their requests or commands into a chat interface or other text input fields, and the agent similarly processes these textual inputs. Other input(s) are possible as well, including explicit or implicit gesture inputs.

In some implementations, the game companion agent can proactively sample and process video frames from the video stream. This proactive approach allows the agent to continuously analyze the game environment, even before the user provides any specific input. For example, the agent might detect changes in the game's scenery or recognize the appearance of new game elements, such as enemies or obstacles, and can prepare potential advice or alerts for the user based on these observations.

Additionally or alternatively to proactive sampling, in some implementations, the game companion agent can sample and process video frames from the video stream in response to user inputs. This means that when a user asks a question or makes a request, the agent specifically analyzes the video frames that are most relevant to that request. For instance, if a user asks for help finding a hidden object, the agent can focus on recent video frames to locate clues or the object itself. Moreover, the agent can examine video frames from a window of time before and/or after the user's input to provide a more comprehensive response. This temporal analysis helps the agent understand the context of the user's request, which can improve the accuracy and relevance of the information provided to the user.

In some implementations, the game companion agent can enhance the model input by utilizing external tools to gather additional contextual information in response to user inputs. This can be referred to as “tool use”. For example, if a user asks for strategies to defeat a particular game level, the agent can use external databases or gaming manuals to retrieve strategies, tips, or cheats related to that specific level. This information can then be integrated into the model input, allowing the agent to provide a more informed and effective response. The use of external tools not only broadens the scope of the agent's capabilities but also increases the likelihood that the advice given is based on a wide array of sources and/or includes current and/or relevant data.

Potential tools that the game companion agent can utilize include online databases containing comprehensive game guides and/or manuals, as well as community-driven platforms such as gaming forums and chat rooms where players discuss strategies, tips, and tricks.

As a particular example of tool use, in some implementations, the game companion agent can perform web searches to obtain contextual information from various online documents in response to user inputs. For instance, when a user asks for details about a specific game character or item, the agent can search the internet to find relevant articles, wiki pages, or news updates that provide detailed descriptions and related information. This gathered data is then incorporated into the model input. This allows the agent to leverage the vast amount of information available on the web to improve the accuracy and relevance of its interactions with the user.

In some implementations, the game companion agent can maintain and utilize current session data to enhance its interactions with the user. This current session data can encompass details of the ongoing gaming session, such as the user's progress, recent actions, preferences expressed during the session, and/or any specific challenges faced. For example, if the user has been struggling with a particular level, the agent can recognize this from the session data and adjust its responses to offer more targeted advice or encouragement. By integrating this session-specific information into the model input, the agent can provide responses that are not only contextually aware but also dynamically adapted to the current state and needs of the user.

Additionally or alternatively to current session data, in some implementations, the game companion agent can utilize prior session data to further personalize the gaming experience. This prior session data can include information from previous interactions with the user across one or more past gaming sessions, such as preferred strategies, frequently encountered difficulties, and/or past achievements or failures. For instance, if a user consistently struggled with a specific type of puzzle in previous sessions, the agent can proactively offer tailored advice or resources when similar challenges arise in future games.

In some implementations, the game companion agent can maintain and utilize a set of interaction rules that provide instructions regarding communications from the agent to the user and/or other aspects of the agent's behavior. These interaction rules can dictate how the agent should respond to various types of inputs and scenarios, ensuring that interactions are consistent, respectful, and user-oriented. For example, interaction rules may instruct the agent to avoid repeating information the user has previously acknowledged, or to escalate the detail in responses when the user expresses confusion or requests further explanation. By incorporating these rules into the generation of the model input, the behavior of the agent can be controlled to align with established guidelines.

In some implementations, the interaction rules can specify that the game companion agent should only comment on visual elements of the in-game environment when these elements are explicitly mentioned by the user. For instance, if a user does not point out a specific character or object within the game, the agent refrains from discussing or referencing it. This rule helps to ensure that the agent's contributions are directly relevant and responsive to the user's current focus and inquiries, thereby avoiding unsolicited or potentially distracting information.

In some implementations, the interaction rules can guide the game companion agent to adjust the length of its responses based on the user's level of engagement. For example, if the user is highly engaged and interactive, asking numerous detailed questions or expressing strong interest, the agent can provide more comprehensive and detailed responses. Conversely, if the user's interaction is minimal or their questions are brief and direct, the agent can limit its responses to concise and direct answers. This adaptive response strategy ensures that the communication style of the agent aligns with the user's current engagement level.

In some implementations, the game companion agent can process inputs that are generated based on captured audio, with specific interaction rules instructing the agent to disregard non-linguistic noise within this audio. For example, background sounds such as music, ambient noises, or unintelligible background speech may be present in the audio captured during gameplay. The agent can be controlled via the interaction rules to identify and ignore these non-linguistic sounds, focusing solely on the user's spoken words to ensure that the responses are not triggered by irrelevant audio.

In some implementations, the interaction rules utilized by the game companion agent can include a set of tags that define delimitations of content within the video stream, the interaction rules themselves, and/or the model output. For example, these tags can be used to categorize and segment different types of visual content, such as game environment elements, character movements, or specific actions, making it easier for the agent to identify and focus on relevant aspects in response to user queries. Additionally, tags can also delineate sections within the interaction rules or model outputs, helping to organize and prioritize the processing of user inputs based on predefined criteria.

In some implementations, the game companion agent utilizes a variety of tags to manage and enhance interactions with the user. Some non-limiting examples are as follows: The [LiveScreenFeed] tag can represent a real-time stream of visual data from the user's screen, capturing all relevant visual elements. The [PastConversations] and [PastDialogue] tags store records of prior interactions. Similarly, [SearchHistory] logs previous web searches to streamline information retrieval and prevent redundancy. The [ActivitySpecificInformation] tag captures data pertinent to the user's current activities, such as game-specific details or design principles, while [AvailableTools] lists the functionalities like web search or language translation that the companion can access. [LongTermMemory] holds persistent data across sessions, enhancing personalization by remembering user preferences and behaviors. Detailed visual data from the screen feed can be categorized under [VisualScreenDetails], used only when explicitly needed. [DeviceCapabilities] informs about the technical specifications of the user's device to ensure optimal interaction. The [MicrophoneAudio] tag captures real-time audio inputs. [UserCurrentTurn] provides immediate context from the user's latest input, and [SessionMemory] contains transient data relevant to the ongoing session. [InstructionsAndTools] define the operational guidelines and tools available to the companion, and [CurrentTimestamp] helps in managing time-sensitive tasks. [GreetingInstructions] guide how the companion should engage or continue dialogue with the user, and [ToolCode] includes specific commands for interacting with the implemented tools, ensuring a smooth and efficient user experience. These tags collectively enable the game companion agent to output responses that are significantly more structured and effective.

In some implementations, when the input associated with the user comprises a request for gameplay assistance, the game companion agent can provide responses that offer guidance tailored to the specific in-game environment. For example, if a user requests help on how to defeat a particular boss in a game, the agent can analyze the current game state and provide strategies or tips that are relevant to that boss's weaknesses and the resources currently available to the player. This targeted assistance helps the user navigate challenges more effectively, enhancing their overall gaming experience by providing context-sensitive support that directly addresses the user's needs within the game environment.

In some implementations, the transformation of the model output into the agent response can vary depending on the complexity and nature of the output. In some cases, the agent response might be identical to the model output, such as directly delivering a retrieved piece of game strategy or a factual answer. However, in other cases, the model output might consist of raw data that includes extraneous information or tags which are not user-friendly. Here, the agent can perform additional processing steps to refine this output, such as stripping out unnecessary tags, reformatting the data into natural language, or synthesizing multiple pieces of information into a coherent and concise response.

In some implementations, the game companion agent can enhance the user's interaction with the game by overlaying visual elements onto the video stream based on the model output. For instance, in response to a user's query about the location of an in-game object or destination, the agent can overlay arrows on the video stream to guide the user to the desired location. Additionally, the agent can include links to relevant game guides or wikis directly on the screen, or even embed video content that provides further explanation or demonstrates gameplay strategies. This method of visually enriched responses makes the guidance more intuitive and accessible.

In some implementations, the game companion agent can actively participate in the gameplay by automatically performing game input actions that affect the game environment. For example, if the user is struggling with a particular task within the game, the agent can execute game actions such as moving the character, selecting items, and/or navigating menus to assist the user. This capability allows the agent to provide not only verbal or visual guidance but also direct intervention in the game.

The video game companion may be particularly advantageous when used in conjunction with touch-based and/or controller-based video games, where user interactions with the game occur through touch inputs on screens and/or through physical controllers. In these settings, the integration of voice interaction becomes particularly valuable. For example, while a user is actively engaging with complex game controls or touch interfaces, voice commands can allow the user to perform these actions without interruption.

Various system configurations can be used to implement the video game and the game companion agent. As one example, the agent can be entirely separate from the video game code, meaning it operates independently and does not interfere with the game's internal operations. This separation allows the agent to optionally be hosted on a different computing device from the one running the game. For example, the game might be executed on a gaming console, while the companion agent runs on a cloud server or a separate PC. Alternatively, the game companion agent can be integrated directly within the video game code, allowing for a more seamless interaction as both the game and the agent are executed on the same device. This setup can simplify the communication between the game and the agent.

Furthermore, while the descriptions contained herein primarily focus on the game companion agent receiving video data, it is also feasible for the agent to receive and process various other forms of observation data relative to the video game. For example, the agent can access real-time game state data, such as player health, inventory items, or current objectives, directly from the game's API. Additionally, the agent could receive telemetry data, which includes player movement patterns, interaction frequencies, and usage statistics of game features. This broader scope of observation data allows the agent to have a more comprehensive understanding of the gameplay and user behavior.

In addition, although the descriptions contained herein primarily focus on the use case where the agent is responding to a user input, in some implementations, the game companion agent is equipped with the capability to proactively react to game events in real-time, independent of direct user inputs. This proactive behavior allows the agent to anticipate potential challenges or opportunities within the game environment, such as notifying the player of impending in-game events or suggesting optimal strategies before critical moments. Based on observation data from the game, the agent can proactively initiate helpful interactions, offering guidance or executing supportive actions that enhance the player's experience and performance without the need for explicit commands from the user.

In some implementations, the game companion agent is configured to operate in a manner that ensures compatibility with anti-tamper or anti-cheat mechanisms associated with the video game. The agent can be associated with a cryptographic signature or a digital certificate that is recognized by an integrity verification system of the computing device or the video game. When the agent attempts to sample the video stream or inject visual elements, the integrity verification system can validate the cryptographic signature. Upon successful validation, the agent is granted trusted status, thereby preventing anti-tamper mechanisms from interpreting the agent's activities (e.g., screen scraping or code injection) as malicious or unauthorized actions.

In some implementations, the game companion agent utilizes a virtual integrity flag provided by the operating system to establish a trusted session. For example, when the video game is executed within a virtualized environment or an emulator managed by a trusted platform provider, the agent can receive a specific integrity verdict (e.g., “meets virtual integrity”). This verdict can serve as a signal to the video game's security protocols that the environment is secure, allowing the agent to perform operations such as capturing the frame buffer or simulating input events without triggering security violations or game termination.

In some implementations, the game companion agent interacts with a system-level resource manager to dynamically adjust the computational resources allocated to the video game and the agent based on a current operating state. For example, the agent can detect specific game states, such as a “loading” state or a “content download” state. In response to detecting a loading state, the agent can signal the resource manager to apply a performance boost, such as ramping up CPU or GPU clock speeds to reduce wait times. Conversely, during graphically intensive gameplay, the agent can act within a defined thermal budget, optimizing its own inference processing—such as by offloading video encoding to dedicated hardware or reducing the sampling rate of the video stream—to effectively prevent thermal throttling of the video game.

In some implementations, the game companion agent employs lifecycle awareness to manage power consumption on the computing device. The agent can monitor the activity level of the overlay interface. When the overlay is collapsed or in a passive monitoring mode, the agent can suspend non-essential background processing or reduce the frequency of network transmission for the video stream. This state-dependent resource management can improve the likelihood that the concurrent operation of the machine-learned model and the video game does not exceed the power capabilities or thermal headroom of the computing device.

In some implementations, the game companion agent serves as a telemetry node for a centralized user engagement platform. The agent can generate data descriptive of user activity metrics across multiple disparate video games, such as session duration, achievement progress, or gameplay streaks. This observation data can be transmitted to a remote platform service that maintains a unified gamer profile for the user. Based on this aggregated data, the platform service can update a user's status or level within a loyalty program, unlocking system-wide rewards, currency, or digital items that are accessible across the user's ecosystem of applications.

In some implementations, the game companion agent is configured to surface additional content derived from a centralized application store or service layer. For example, based on observing that a user has completed a specific gameplay milestone or level, the agent can retrieve and display relevant content from the application store, such as a coupon for in-game items, a suggestion for a related video, or a notification regarding a community challenge. This integration allows the agent to function as a dynamic service layer that fosters continued engagement by linking the specific context of the current game session with the broader offerings of the platform ecosystem.

In addition, although the descriptions contained herein primarily focus on the use of the game companion agent within video games, similar techniques can be adapted to provide one or more agents for one or more other interactive environments. The agent for each interactive environment can receive observations of the environment and generate outputs based on the observations. As examples, the agent can provide commentary or instructions to a user regarding the environment and/or can directly interact with the environment via one or a sequence of autonomous action(s).

As one example, an interactive environment can include a user interface (e.g., a graphical user interface) provided by a computing system. As one example, the user interface can be a system-level interface such as an operating system interface. As another example, the user interface can be a user interface of a particular software application, such as a web browser application. For example, the interactive agent might perform actions such as navigating through pages or portions of a web document being browsed by the browser application, for example adding items to a shopping cart and/or processing checkouts.

To provide an example, a user can interact with an interactive agent by providing voice commands or typing requests for booking a flight. For instance, the user could specify the desired travel dates, destination, and preferences for flight times or airlines. The interactive agent can interact with a graphical user interface (e.g., of a web browser application or of a dedicated travel application) to retrieve available flight options that match the user's criteria. The agent could present these options to the user through the graphical user interface, allowing the user to review and make selections. Alternatively, the agent could proactively perform a booking if instructed to do so by the user. Additionally, the agent could assist in completing the booking by filling in passenger details, processing payments, and confirming the reservation.

Alternatively or additionally to directly interacting with the user interface, the agent could output commentary or instructions to the user that helps the user perform the necessary actions to complete the requested booking. For example, given a user query such as “How can I book multi-city flights?”, the agent can evaluate the user interface and respond with instructions (e.g., output as audio and/or text) that provide guidance or instructions to the user about how to perform the requested operation (e.g., “To book a multi-city flight, first change the setting in the blue box at the top of the page from Roundtrip to Multi-City.”). As yet another example, the agent can provide guidance, commentary, or instructions with respect to past states or observations of the user interface. For example, the user may request and receive a set of multiple flight results for different destinations (e.g., New York City, London, Paris). The agent may observe the state of the user interface at this time. The user may then navigate away from this results page to a different page (e.g., the user may select a particular destination of the multiple different destinations, such as London). At this later point, the user might query “How does this price to London compare to the best price to New York City?” Although the state of the user interface no longer depicts information regarding flights to New York City, the agent can leverage the past observation (e.g., stored in a memory layer or as other stored contextual data), to respond with an accurate response to the query that compares the price of the flight to London (e.g., as shown on the current interface) to the price of the flight to New York City (e.g., as was shown on the prior interface).

As another example, an interactive environment can include a virtual reality environment, a mixed reality environment, or an augmented reality environment. An interactive agent can guide users through virtual tours or training simulations, provide real time feedback, and/or otherwise provide guidance to the user as they navigate the environment. As another example, an interactive environment can dynamically interact with the environment (e.g., as a companion to the user). For example, the interactive agent may simulate a partner, teammate, adversary, or other participant in the environment.

As another example, in a home automation system, an interactive agent can adjust settings on smart home devices. Actions in this environment might include altering thermostat settings, turning lights on or off, or monitoring security cameras. These actions help in managing the household more efficiently and can adapt to the preferences of the user over time.

As another example, in a customer service environment, such as a support chat interface, an interactive agent can perform actions including greeting customers, answering frequently asked questions, and escalating issues to human operators. This not only speeds up response times but also ensures that customers receive consistent and accurate information.

As another example, in educational software, an interactive agent can guide students through learning modules, assess responses to quizzes, and provide adaptive feedback based on student performance. Actions here can include presenting educational content, evaluating answers, providing instructional feedback, and adapting future content to suit the learning pace and style of the student.

As another example, in an autonomous vehicle environment, an interactive agent can manage a variety of vehicle-related tasks. Actions might include navigating routes, detecting and reacting to road signs and obstacles, adjusting speed or other operational parameters based on traffic conditions, and managing emergency responses like braking or evasive maneuvers.

As another example, in a factory setting, an interactive agent can be integrated into manufacturing processes where it might control robotic arms, manage assembly lines, or monitor quality control systems. Actions in this environment could include scheduling maintenance, optimizing production workflows, and detecting faults in machinery.

As another example, within a laboratory setting, for example in fields such as protein folding or drug development, an interactive agent can perform various tasks. Actions here can include setting up simulations, analyzing molecular interactions, or automating the handling and mixing of chemical substances.

As another example, in a systems control setting, such as in power plants or network operations centers, an interactive agent can monitor system performance, predict potential failures, and initiate corrective measures. Actions might include adjusting loads, redistributing resources in real-time, or shutting down systems safely in case of anomalies.

As another example, in space exploration applications, an interactive agent can operate spacecraft systems, manage data collection from scientific instruments, or simulate mission scenarios. Actions could include maneuvering spacecraft, analyzing extraterrestrial material, or maintaining life-support systems.

As another example, in a healthcare setting, an interactive agent can be used, with patient consent, within electronic health record systems to schedule appointments, send reminders for medication, or assist a human caretaker in diagnosing medical conditions by analyzing symptoms and patient history.

As another example, in the field of logistics and supply chain management, an interactive agent can optimize warehouse operations by automating inventory checks, coordinating shipping schedules, and routing delivery vehicles using real-time traffic data.

As another example, in a manufacturing context, an interactive agent can monitor equipment performance, predict maintenance needs, and adjust production schedules based on machine learning algorithms that analyze operational data.

As another example, an interactive agent can manage traffic flow, coordinate public transportation schedules, and monitor energy consumption across different districts or geographies. Actions here include adjusting traffic signal timings, rerouting buses to avoid congestion, and dynamically controlling street lighting based on pedestrian and vehicle presence to optimize energy usage.

As another example, in a robotic surgical system or other automated medical system, an interactive agent can perform precise actions such as manipulating surgical or other medical instruments, adjusting camera angles, and monitoring vital signs during procedures.

As another example, in the field of agriculture, an interactive agent can manage automated farming equipment such as tractors, seed planters, and irrigation systems. Here, the agent's actions can include adjusting sowing patterns based on soil health data, regulating water distribution for optimal plant growth, and monitoring crop health through drone imagery analysis.

Another aspect of the present disclosure can improve the efficiency of models processing textual data in user interface (UI) action and screen understanding applications. In particular, standard tokenizers utilized in these models (e.g., which may include large language models, sequence processing models, etc.) may encounter challenges with HTML/DOM-heavy tasks due to suboptimal compression, which can lead to increased latency. This inefficiency primarily arises because HTML tags are infrequently encountered during the training of these tokenizers, resulting in their inadequate recognition as standard tokens.

To address this issue, some example implementations can incorporate HTML tags as user-defined tokens within the tokenizer's vocabulary. For example, HTML tags such as <a>, <html>, <body>, <img>, <span>, <bbox>, <ul>, <li>, <div>, <iframe>, <footer>, along with their respective closing tags, can be added as additional tokens. By integrating these tags directly into the tokenizer, the model can more readily recognize and process HTML/DOM-heavy content. This increased ability can reduce latency and improve the performance of UI-action and screen understanding tasks.

The systems and methods of the present disclosure provide a number of technical effects and benefits. As one example, the game companion agent significantly improves the user experience by providing real-time, context-sensitive assistance during gameplay. This is achieved through the agent's capability to process and analyze both live video streams and user inputs, enabling it to offer strategic guidance and/or perform game-related actions automatically. This reduces the cognitive load on players, allowing them to focus on strategic decision-making rather than routine tasks.

As another example technical benefit, the agent's capability to selectively process video and audio streams from the gaming environment can lead to a more efficient use of computational resources. By focusing only on relevant segments of data, such as those directly associated with a user's query or actions, the agent minimizes unnecessary processing, thereby reducing computational load and improving response times.

As yet another example technical effect and benefit, the agent's ability to operate independently from the game's primary computing platform, or directly within it, demonstrates flexibility in deployment. This adaptability can optimize system performance and resource allocation based on the specific hardware capabilities and user preferences.

Various example implementations are described herein with respect to the accompanying Figures.

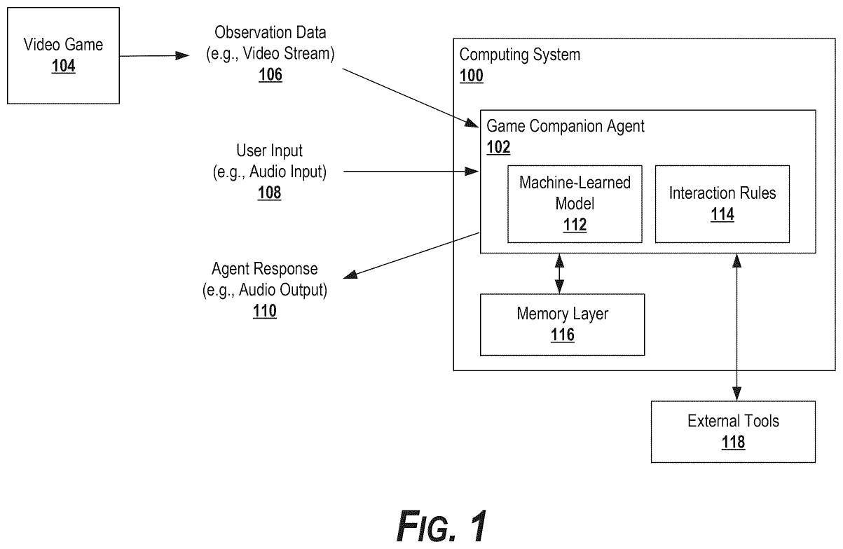

FIG. 1 illustrates a schematic diagram of a computing system 100 that incorporates a game companion agent 102. The game companion agent 102 can be configured to interact with a video game 104, from which it receives, collects, or otherwise obtains observation data 106. As one example, the observation data 106 can include a video stream of the video game 104. The game companion agent 102 can also be configured receive user input 108 and based on this, the agent can generate an agent response 110. As one example, the user input 108 can be an audio input. As one example, the agent response 110 can be an audio output.

The computing system 100 can serve as the computational platform for the game companion agent 102 and its associated components. This system can be implemented on a variety of hardware configurations such as personal computers, gaming consoles, or cloud-based servers. The computing system 100 can facilitate the processing and integration of inputs and outputs related to the video game environment and user interactions. For example, computing system 100 can host the software necessary to run the game companion agent 102, manage data flow between the machine-learned model 112 and external tools 118, and apply interaction rules 114.

The game companion agent 102 can operate within computing system 100 to enhance the interaction between the user and the video game. It can process observation data 106 and user input 108 to generate context-sensitive responses, which are then delivered as agent response 110. Examples implementations of the game companion agent 102 include software applications running on a gaming console or a dedicated server where the agent uses algorithms to analyze data and interact with the user. The agent can also be integrated as a part of the video game's software.

As shown in FIG. 1, within the game companion agent 102, a machine-learned model 112 can be utilized to process inputs and generate outputs. The agent 102 can also include interaction rules 114, which can control or condition how the machine-learned model 112 processes inputs and generates outputs. The machine-learned model 112 can or include advanced machine learning algorithms, such as neural networks or other forms of machine-learned models. The machine-learned model 112 can understand and respond to complex inputs in a dynamic gaming environment. For instance, machine-learned model 112 might use a Transformer-based architecture to analyze text and video data simultaneously, enabling it to provide responses that are both accurate and contextually relevant. Example multimodal models include Gemini 1.5 (see, e.g., Gemini Team Google, et al., Gemini 1.5: Unlocking multimodal understanding across millions of tokens of context, arXiv: 2403.05530 (2024)) and PaliGemma2 (see, e.g., Steiner, et al., PaliGemma 2: A Family of Versatile VLMs for Transfer, arXiv:2412.03555v1 (Dec. 4, 2024)).

The game companion agent 102 can also include interaction rules 114. The interaction rules 114 can be instructions that dictate, control, and/or condition the behavior of the agent in response to various types of inputs and situations. These rules can be included as a portion of a model input (e.g., “prompt” or other input data structure).

A memory layer 116 is also shown as part of the computing system 100. The game companion agent 102 can store or cache data within the memory layer 116, such as user preferences, game states, or historical interaction data. For example, memory layer 116 might store information about the user's progress in a game, which can be used to offer personalized tips or help resolve specific challenges faced by the user. The memory layer 116 could include current session data and/or prior session data.

Additionally, the game companion agent 102 can interact with external tools 118, which can provide additional functionalities or data necessary for the agent to perform its tasks effectively. These external tools 118 can include databases, APIs, or other software tools that enhance the capabilities of the game companion agent 102 by providing access to a broader range of information or processing power. For example, external tools 118 might include a database of game walkthroughs or a cloud-based service that provides real-time data analysis capabilities, which the agent can access to offer more detailed and effective assistance to the user.

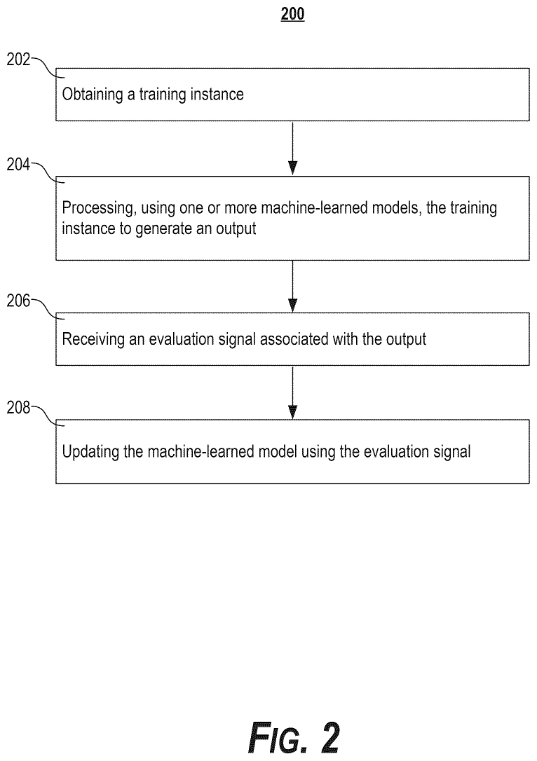

FIG. 2 depicts a flowchart of a method 200 for training one or more machine-learned models according to aspects of the present disclosure. For instance, an example machine-learned model can include a sequence processing model.

One or more portion(s) of example method 200 can be implemented by a computing system that includes one or more computing devices such as, for example, computing systems described with reference to the other figures. Each respective portion of example method 200 can be performed by any (or any combination) of one or more computing devices. Moreover, one or more portion(s) of example method 200 can be implemented on the hardware components of the device(s) described herein, for example, to train one or more systems or models. FIG. 2 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 2 is described with reference to elements/terms described with respect to other systems and figures for exemplary illustrated purposes and is not meant to be limiting. One or more portions of example method 200 can be performed additionally, or alternatively, by other systems.

At 202, example method 200 can include obtaining a training instance. A set of training data can include a plurality of training instances divided between multiple datasets (e.g., a training dataset, a validation dataset, or testing dataset). A training instance can be labeled or unlabeled. Although referred to in example method 200 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 204, example method 200 can include processing, using one or more machine-learned models, the training instance to generate an output. The output can be directly obtained from the one or more machine-learned models or can be a downstream result of a chain of processing operations that includes an output of the one or more machine-learned models.

At 206, example method 200 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 208, example method 200 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 200 can include implementing a number of generalization techniques (e.g., weight decays, dropouts, etc.) to improve the generalization capability of the models being trained.

In some implementations, example method 200 can be implemented for training a machine-learned model from an initialized state to a fully trained state (e.g., when the model exhibits a desired performance profile, such as based on accuracy, precision, recall, etc.).

In some implementations, example method 200 can be implemented for particular stages of a training procedure. For instance, in some implementations, example method 200 can be implemented for pre-training a machine-learned model. Pre-training can include, for instance, large-scale training over potentially noisy data to achieve a broad base of performance levels across a variety of tasks/data types.

In some implementations, example method 200 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 200 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 200 can be implemented to execute parameter-efficient fine-tuning methods, such as Layerwise Optimization of Residuals (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

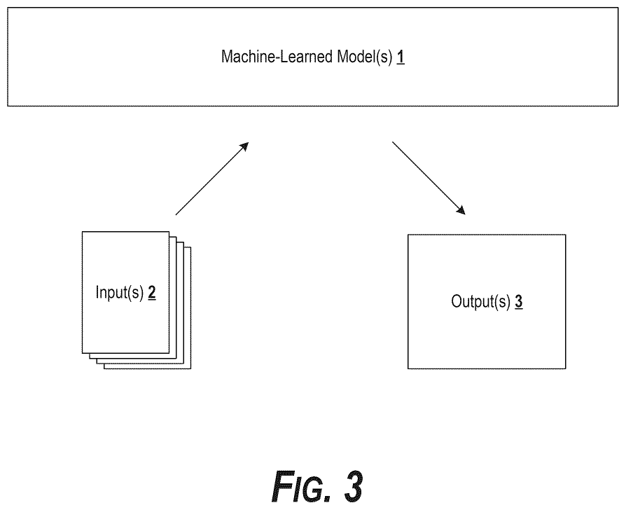

FIG. 3 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. For example, machine-learned model(s) 1 can be or include, or otherwise be representative of any one or more of the models described herein, etc. Although various features, variations, and implementations described below are described with respect to machine-learned model(s) 1, it is to be understood that such features, variations, and implementations are to be understood as described with respect to each of the models describe herein, etc., and any other machine-learned component described herein.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

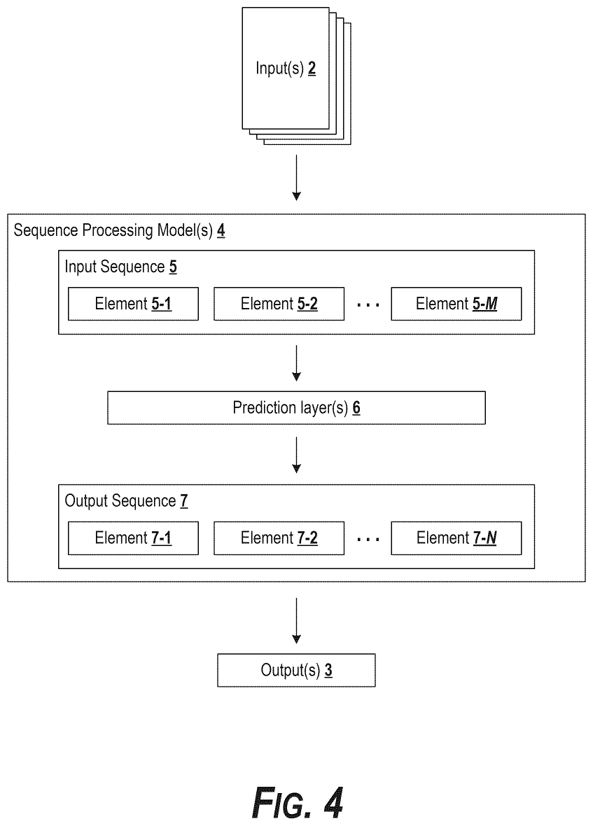

FIG. 4 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2, . . . , 5-M, etc. obtained from input(s) 2. Sequence processing model 4 can process input sequence 5 using prediction layer(s) 6 to generate an output sequence 7. Output sequence 7 can include one or more output elements 7-1, 7-2, . . . , 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 4 can be the tokens or can be the embedded representations thereof.

Prediction layer(s) 6 can predict one or more output elements 7-1, 7-2, . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

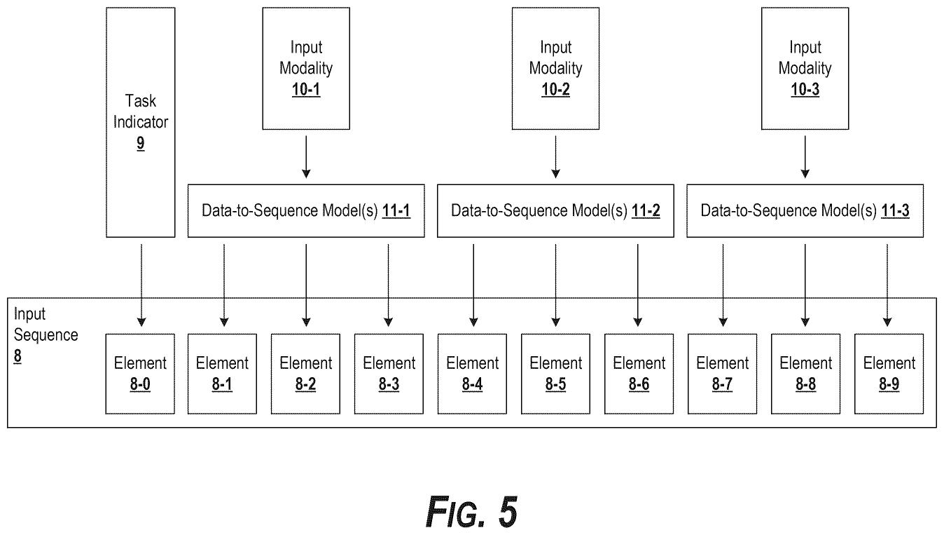

FIG. 5 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

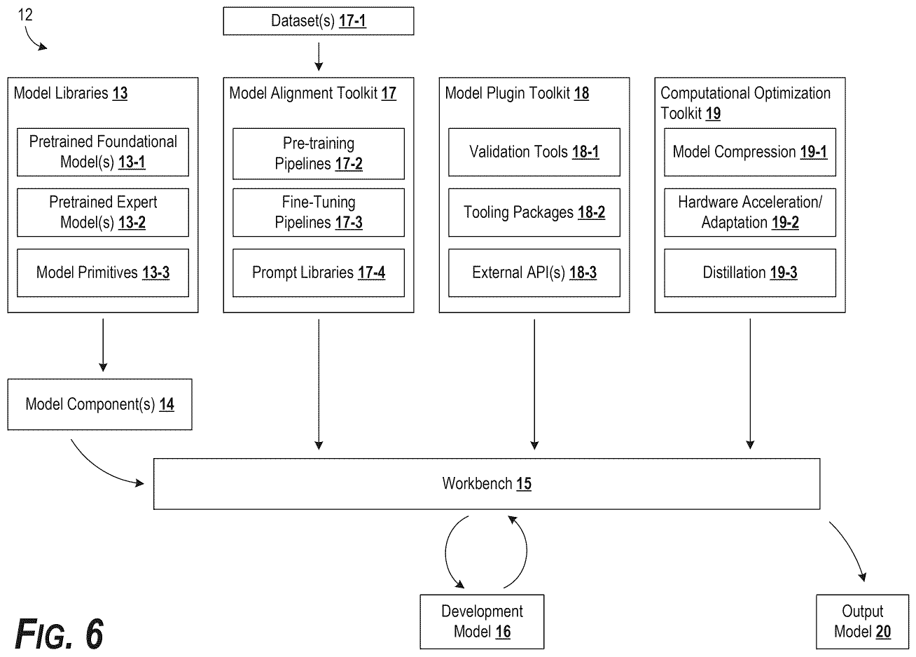

FIG. 6 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 200 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

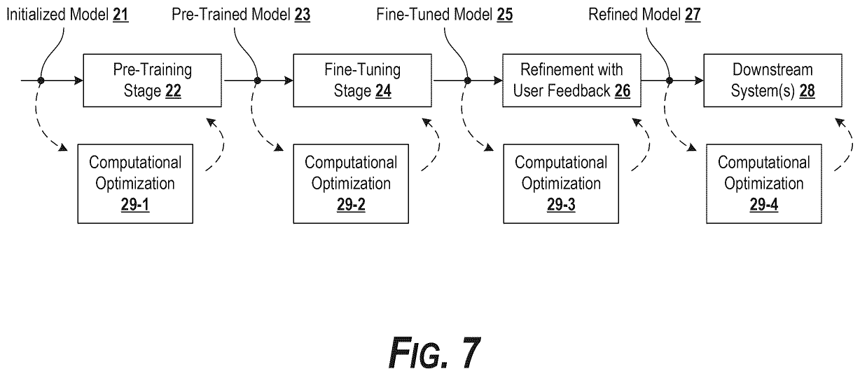

FIG. 7 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1, . . . , 29-4 can all be the same, all be different, or include at least some different optimization techniques.

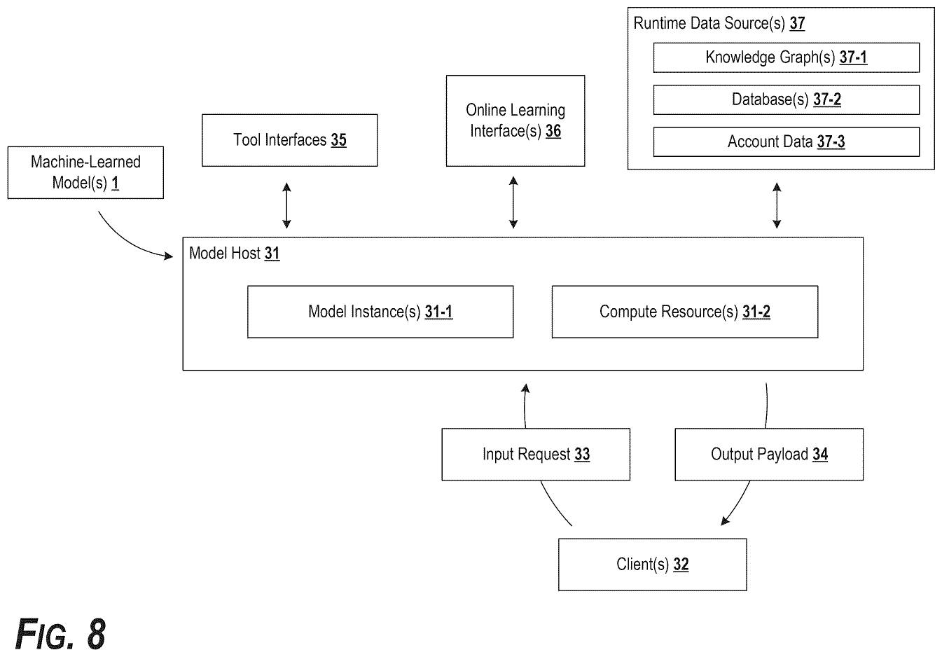

FIG. 8 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

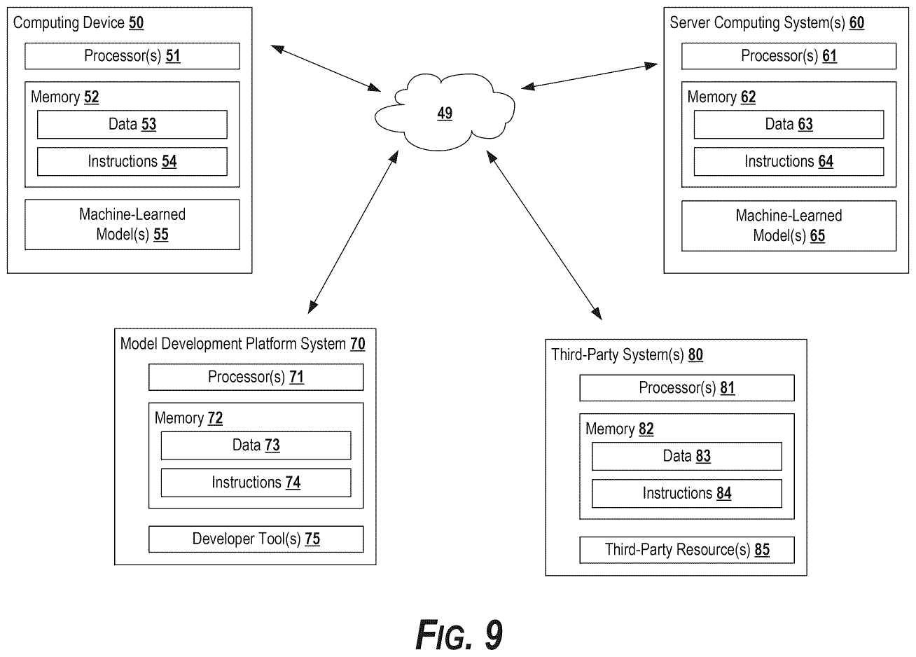

FIG. 9 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 9 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 9 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

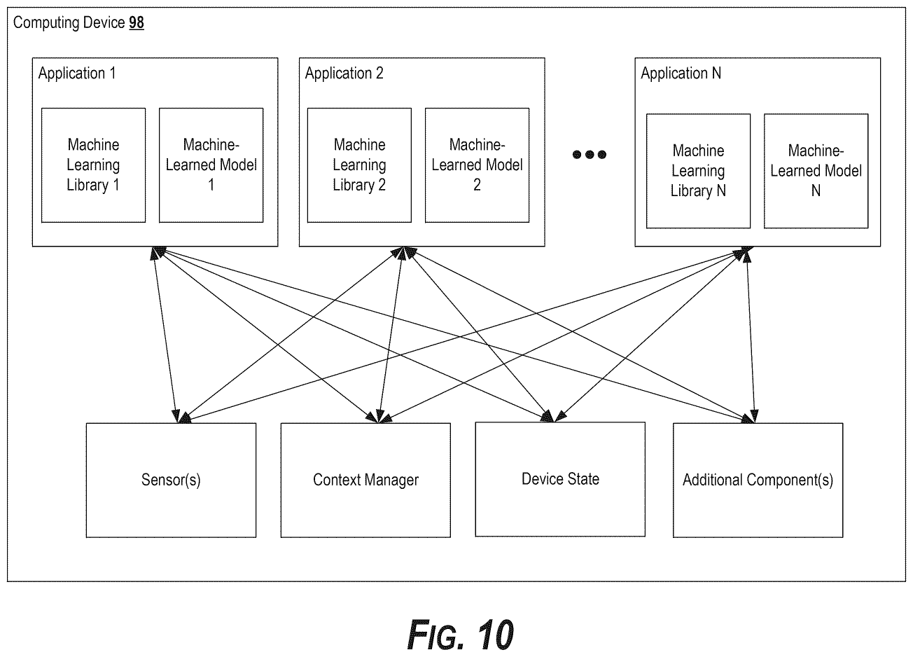

FIG. 10 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 10, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

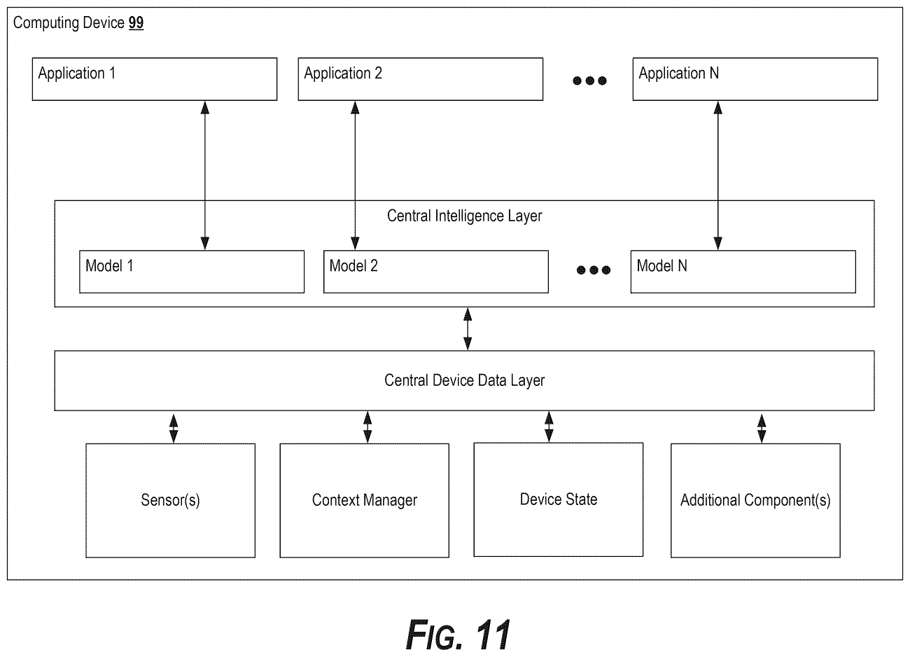

FIG. 11 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 11, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 11, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computer-implemented method, comprising:
receiving, by a game companion agent, an input associated with a user;
sampling, by the game companion agent, a video stream associated with a user, wherein the video stream depicts an in-game environment associated with a video game played by the user;
generating, by the game companion agent, a model input based on (i) at least a portion of the video stream and (ii) the input associated with the user;
generating, by the game companion agent and based on processing the model input using a machine-learned sequence processing model, a model output; and
outputting, by the game companion agent, and based on the model output, a response to the input associated with the user.

2. The computer-implemented method of claim 1, wherein the input associated with the user comprises a speech input uttered by the user.

3. The computer-implemented method of claim 1, wherein the input associated with the user comprises a textual input entered by the user.

4. The computer-implemented method of claim 1, wherein the game companion agent proactively samples and processes video frames from the video stream.

5. The computer-implemented method of claim 1, wherein the game companion agent samples and processes video frames from the video stream in response to the input associated with the user.

6. The computer-implemented method of claim 1, wherein the game companion agent samples and processes video frames from a window before and after a timestamp associated with the input associated with the user.

7. The computer-implemented method of claim 1, wherein generating, by the game companion agent, the model input comprises performing, by the game companion agent and in response to the input, tool use to obtain contextual information from one or more external tools, wherein the contextual information is included in the model input.

8. The computer-implemented method of claim 1, wherein generating, by the game companion agent, the model input comprises performing, by the game companion agent and in response to the input, a web search to obtain contextual information from one or more web documents, wherein the contextual information is included in the model input.

9. The computer-implemented method of claim 1, wherein:
the method further comprises maintaining, by the game companion agent, current session data associated with a current gaming session with the user, and
generating, by the game companion agent, the model input comprises generating, by the game companion agent, the model input based at least in part on the current session data.

10. The computer-implemented method of claim 1, wherein:
the method further comprises maintaining, by the game companion agent, prior session data associated with one or more prior gaming sessions with the user, and
generating, by the game companion agent, the model input comprises generating, by the game companion agent, the model input based at least in part on the prior session data.

11. The computer-implemented method of claim 1, wherein:
the method further comprises maintaining, by the game companion agent, interaction rules associated with interacting with the user, and
generating, by the game companion agent, the model input comprises generating, by the game companion agent, the model input based at least in part on the interaction rules.

12. The computer-implemented method of claim 11, wherein the interaction rules instruct the game companion agent to (i) only comment on visual elements of the in-game environment when the user explicitly mentions the visual elements or (ii) tailor a response length based on a level of engagement associated with the user.

13. The computer-implemented method of claim 1, wherein the input associated with the user comprises a request for gameplay assistance, and wherein the response to the input comprises guidance relative to the in-game environment.

14. The computer-implemented method of claim 1, wherein outputting, by the game companion agent, and based on the model output, the response to the input comprises overlaying, by the game companion agent, one or more visual elements onto the video stream.

15. The computer-implemented method of claim 1, wherein outputting, by the game companion agent, and based on the model output, the response to the input comprises automatically performing, based on the model output, a game input action relative to game environment, the game input action affecting the game environment.

16. The computer-implemented method of claim 1, wherein the video game is a touch-based or controller-based game in which the user interacts with the video game via touch interactions or via inputs to a physical controller.

17. The computer-implemented method of claim 1, wherein the game companion agent is separate from video game code executing the video game.

18. The computer-implemented method of claim 1, wherein the game companion agent is executed by one or more first computing devices and wherein the video game is executed by one or more second computing devices that are separate from the one or more first computing devices.

19. The computer-implemented method of claim 1, wherein the game companion agent is contained within video game code executing the video game.

20. A computer system, comprising:
one or more processors; and
one or more non-transitory computer-readable media that collectively store instructions executable by the one or more processors to implement a machine-learned based game companion agent, the game companion agent configured to perform operations comprising:
receiving, by the game companion agent, an input associated with a user;
obtaining, by the game companion agent, observation data descriptive of an in-game environment associated with a video game played by the user;
generating, by the game companion agent, a model input based on (i) at least a portion of the observation data and (ii) the input associated with the user;
generating, by the game companion agent and based on processing the model input using a machine-learned sequence processing model, an output; and
outputting, by the game companion agent, and based on the output, a response to the input associated with the user.
